(19) United States
(12) Patent Application Publication
(10) Pub. No.: US 2020/0146254 A1
(43) Pub. Date: May 14, 2020

(54) SEPARATING DEVICE FOR A LIVESTOCK CUBICLE AND ARRANGEMENT THEREOF, IN PARTICULAR FOR A DAIRY FARM

(71) Applicant: GEA Farm Technologies GmbH, Bonen (DE)

(72) Inventor: Sake Oevering, Kollumerzwaag (NL)

(21) Appl. No.: 16/676,719

(22) Filed: Nov. 7, 2019

Related U.S. Application Data
(60) Provisional application No. 62/757,808, filed on Nov. 9, 2018.

(30) Foreign Application Priority Data
Nov. 9, 2018 (DE) 202018106372

(51) Int. Cl. A01K 1/00

(52) U.S. Cl. CPC A01K 1/0011

(57) ABSTRACT

A separating device for a dairy farm livestock cubicle having a head region, a rear region, a first vertical separating unit, a second vertical separating unit spaced apart from the first vertical separating unit, and a substantially horizontally arranged crossmember extending through an obliquely arranged guide on one of the vertical separating units.

### CROSS REFERENCE TO RELATED APPLICATION

This application claims the benefit of U.S. Provisional Application 62/757,808, filed Nov. 9, 2018, and German Utility Modal Application No. 202018106372, filed Nov. 9, 2018 the disclosures of which are incorporated by reference herein.

### FIELD AND BACKGROUND OF THE INVENTION

The present invention relates to a separating device for a livestock cubicle, in particular for a dairy farm, as well as to an arrangement, in particular for a dairy farm, which comprises a plurality of livestock cubicles.

Livestock cubicles for dairy farms are known from the prior art. The cows of the dairy farm are able to lie in such livestock cubicles in a stall. Known livestock cubicles generally have a crossbar—which is also denoted as a neck rail—which prevents the forward movement of the cow out of the cubicle and/or induces the cow to lie down in the livestock cubicle. Known crossbars may lead to the cow having difficulties when standing up, in particular when the cow is in a poor state of health. This may have the result that a cow which is not able to stand up due to the crossbar continues to move forward out of the livestock cubicle. In this case, the cow may move so far out of the livestock cubicle that it is injured on the back by the crossbar. A similar problem results when a cow is panicked. In such a situation a cow will attempt to leave the livestock cubicle toward the front. It is prevented from doing so by the crossbar, wherein it may be injured on the back on the crossbar according to the prior art.

### SUMMARY OF THE INVENTION

Proceeding therefrom, it is the object of the present invention to solve and/or at least to reduce the technical problems set forth in connection with the prior art. In particular, a separating device for a livestock cubicle and an arrangement thereof, in particular for a dairy farm, are to be proposed, in which the risk of injury to an animal located in the livestock cubicle is particularly low.

These objects are achieved by a separating device and an arrangement according to the protected independent claims. Further advantageous embodiments are specified in the protected dependent claims which are respectively formulated. The features set forth individually in the claims are able to be combined together in any technologically expedient manner and may be complemented by explanatory technical content from the description, wherein further variants of the invention are disclosed.

According to the invention, a separating device for a livestock cubicle having a head region and a rear region, in particular for a livestock cubicle for a dairy farm, is proposed. The separating device comprises
a first vertical separating unit,
a second vertical separating unit, wherein the first and the second separating unit are arranged spaced apart from one another,
a substantially horizontally arranged crossmember.

Each separating unit comprises a holder with a guide, the crossmember extending through said guide, wherein the guide is oriented obliquely such that with an upward movement the crossmember is also moved in the direction of the rear region of the livestock cubicle and the guide and an imaginary horizontal line extending parallel to the respective separating unit enclose a guide angle which is less than 90°.

The livestock cubicle is defined laterally by means of the described separating device. The livestock cubicle is preferably intended and designed for cows of a dairy farm. For example, a plurality of such livestock cubicles may be provided in a stall of a dairy farm. Alternatively, however, it is also possible that the livestock cubicle is intended and designed for other animals. The head region of the livestock cubicle is intended such that an animal lying in the livestock cubicle holds its head in the head region. The rear region of the livestock cubicle is intended such that the rear part of the animal lying in the livestock cubicle lies here. The head region and the rear region are, in particular, used here for directional information and thus indicate where “front” and “rear” is in the livestock cubicle.

The described separating device comprises the first vertical separating unit and the second vertical separating unit. The livestock cubicle is defined on both sides by means of these separating units. As the separating units are arranged spaced apart from one another, the livestock cubicle is configured such that the animal is able to lie between the separating units. “Vertical” means in this context that the separating units are oriented perpendicular to the floor of the livestock cubicle. The orientation of the separating units in this case refers to the orientation of a plane spanned in each case by the separating units.

The first separating unit and the second separating unit are preferably configured identically to one another.

The separating device further comprises the substantially horizontally arranged crossmember. Preferably, the crossmember is arranged horizontally. “Horizontal” means in this context that the crossmember is oriented parallel to the floor of the livestock cubicle. Preferably, the crossmember is arranged perpendicular to the separating units.

If an animal, in particular a cow, moves into the livestock cubicle the effect of the crossmember may be such that the animal is induced to lie down. In this case, by the arrangement of the crossmember and/or the separating units it is possible to influence in which position and at which point the animal lies down. This has the advantage, in particular, that space present in a stall may be utilized in the best possible manner.

In the case of the crossmember configured as described above, the risk of injury to an animal located in the livestock cubicle is considerably reduced relative to the above-described crossbar according to the prior art. This is achieved, in particular, by the crossmember not being retained rigidly but being retained by the guide of the holders. The guide in this case is preferably configured such that the crossmember may move freely over a guide length. Thus the guide preferably extends between a lower stop and an upper stop, the crossmember being able to move therebetween. The terms “upper” and “lower” refer in this case to the conventional orientation of the separating units with the intended use of the separating device.

The guide is preferably of linear configuration. This means that the movement of the crossmember is limited by the guide to one dimension. As a result, a movement of the crossmember is only possible within the guide, whilst in particular a movement transversely to the guide, in any case with the intended use of the separating device, i.e. in particular without dismantling, damaging and/or destroying parts thereof, is not possible. Preferably, the guide is configured such that the crossmember may be moved from the lower stop obliquely upwardly such that the crossmember is moved at the same time in the direction of the rear region of the livestock cubicle. This may also be denoted as a movement obliquely upwardly and to the rear. From the upper stop the crossmember may be moved obliquely downwardly such that the crossmember at the same time is moved away from the rear region of the livestock cubicle. This is a movement of the crossmember obliquely downwardly and to the front.

The described possibility of the oblique movement of the crossmember is implemented by the described guide angle. The guide angle is the angle which is enclosed by the guide, on the one hand, and a horizontal line, on the other hand, wherein the horizontal line is oriented parallel to the respective separating unit. This means that the horizontal line, on the one hand, is oriented parallel to the floor of the livestock cubicle and, on the other hand, the horizontal line is preferably located in a plane parallel to the floor of the livestock cubicle perpendicular to the crossmember. The guide and the horizontal line enclose, as is always the case with two straight lines intersecting, four angles with one another, in each case two pairs thereof being identical. Of these four angles the guide angle is that which is arranged above the imaginary horizontal line and on the side of the rear region of the livestock cubicle. The guide angle is thus identical to the angle which the guide encloses with the horizontal line on the side of the head region below the horizontal line. Preferably, the guide angles of the two holders are identical.

By means of the described guide of the crossmember, it may be achieved that an animal, in particular a cow, is not prevented by the crossmember from standing up and as a result being potentially injured. By the oblique orientation of the guide it may also be achieved that the animal feels a resistance when attempting to leave the livestock cubicle toward the front, i.e. in the direction of the head region and/or also beyond the head region. This has the advantage that it is made difficult for the animal to leave the livestock cubicle toward the front so that the animal does not generally leave the livestock cubicle. However, if the cow has left the livestock cubicle toward the front or the cow is at least further forward in the livestock cubicle than envisaged, the oblique orientation of the guide facilitates the cow being able to move further back into the livestock cubicle.

By the oblique orientation of the guide it is thus achieved that a cow, on the one hand, may only leave the livestock cubicle toward the front with difficulty, since to this end the crossmember has to be moved upwardly and counter to the direction of movement of the cow. On the other hand, however, the cow may easily re-enter the livestock cubicle of its own accord, since with such a rearward movement the crossmember has to be moved upwardly and in the direction of movement of the cow.

The holders are preferably configured such that the described guide of the crossmember may be configured by the holders. Preferably, the holders of the two separating units are configured identically to one another. It is also preferred if both holders are oriented parallel to one another. Preferably, both holders are oriented such that the guide is configured in a plane parallel to one respective plane of the separating unit. For example, the holders may be of plate-like configuration, wherein the guide is configured as an opening in the holder. The holders of plate-like configuration are preferably oriented perpendicular to the floor of the livestock cubicle and/or perpendicular to the crossmember.

According to a preferred embodiment of the separating device, the guide angle is greater than 60°.

With a smaller guide angle there could be the risk that an animal lying in the livestock cubicle, in particular a cow, is injured when attempting to stand up. This may result, in particular, in the crossmember not being moved upwardly in the guide but due to the small guide angle remaining suspended in a lower region of the guide.

According to a further preferred embodiment of the separating device, the guide angle ranges between 70° and 80°.

It has been shown that with a guide angle in the specified range, the above-described advantages may be achieved to a specific degree.

According to a further preferred embodiment of the separating device, the holders are configured such that the guide angle is unalterable.

“Unalterable” means that in any case with the intended use of the separating device, i.e. in particular without dismantling, damaging and/or destroying parts thereof, the guide angle is always of the same size. This facilitates, in particular, the production of the holders. The unalterability of the guide angle may be achieved, in particular, by the holder being configured from a metal and/or a hard inflexible plastics material.

It is, however, also possible within the scope of the present embodiment that the guide angle is increased or reduced by a structural alteration. This is possible, for example, by the holder being released from the remaining separating unit and being reconnected to the separating unit in a different orientation. Such a release and reconnection is not the intended use in the previously described meaning but a reconfiguration. By such a reconfiguration, the separating device for use by a first animal may be reconfigured for use by a second animal. Thus one and the same separating device, for example, may be used for cows of different sizes. The reconfiguration may be facilitated, in particular, by the holders being able to be mounted in a plurality of predetermined orientations, for example by a plurality of holes being provided, in each case some thereof being able to be used for fastening the holder, in particular by means of screws or bolts.

According to a further preferred embodiment of the separating device, the crossmember is retained loosely in the holders.

By the loose retention, the risk of injury to the animal may be particularly reduced. “Loose” means that no means are provided in order to increase the friction of the crossmember on the guide. According to a further preferred embodiment of the separating device, the holders are of rigid configuration.

“Rigid” means that in the case of the forces usually occurring during the operation of the separating device the holders are not able to be significantly distorted. Such rigidly configured holders may be particularly robust and thus have particularly long service lives. Rigidly configured holders may, for example, be formed from metal or a hard plastics material. It is particularly preferred if the holders are configured in each case as a steel plate, in particular with a thickness ranging from 1 cm to 5 cm, preferably ranging from 2 cm to 4 cm.

According to a further preferred embodiment of the separating device, the crossmember is configured as a straight bar.

In this embodiment, the crossmember is oriented over the entire length thereof parallel to the floor of the livestock cubicle. In particular, no kinks or bent regions are present in the path of the crossmember, which could lead to injuries of an animal in the livestock cubicle.

Alternatively, it is preferred if the crossmember is configured as a cable, in particular a steel cable, a strap or a belt.

According to a further preferred embodiment of the separating device, the guide has a guide length of at least 20 cm, in particular of at least 30 cm.

According to a further preferred embodiment of the separating device, the guide has a guide length of a maximum of 50 cm, in particular of a maximum of 40 cm.

“Guide length” is to be understood as the length which is available for the movement of the crossmember along the guide. The guide length is measured along the guide and extends from a lower stop to an upper stop. It is particularly preferred that the guide length is identical in all of the holders.

It has been shown that with the described guide lengths the risk of injury to the animals is particularly low. This applies, in particular, to cows.

According to a further preferred embodiment of the separating device, the first separating unit and/or the second separating unit are configured from one or more tubes.

It is preferred if the first separating unit and the second separating unit are configured in each case from one or more tubes.

The tubes are preferably formed from metal. As a result, a particularly high degree of stability may be achieved. It is also preferred if the tubes have a round cross section. As a result, a risk of injury to an animal in the livestock cubicle may be limited in a particularly effective manner. According to a further preferred embodiment of the separating device, the first separating unit and/or the second separating unit comprise one respective post connected to a floor of the livestock cubicle, and wherein the respective holder is retained on the corresponding post.

The post is preferably configured as a tube, in particular with a round cross section. The post preferably has a first region, the post being fastened thereby to the floor of the livestock cubicle. The post preferably also has a second region which adjoins the first region. The second region is preferably configured perpendicular to the floor of the livestock cubicle. The first region is preferably configured to be bent such that the second region is offset in the direction of the rear region of the livestock cubicle relative to a fastening point at which the post is fastened to the floor of the livestock cubicle. By such an embodiment of the separating unit, the anatomy and the behavior of the cows may be taken into account in a particularly effective manner.

The holder is preferably connected to the post at the end of the second region remote from the first region. The connection is preferably configured by screws or bolts.

Preferably a loop is mounted on the post. The loop preferably defines a plane of the separating unit, in particular by a first region and a second region of the loop being arranged in each case parallel to the floor of the livestock cubicle, wherein the two regions are connected in each case at one end to the post and in each case at the other end transition into one another via a deflection region.

According to a further preferred embodiment of the separating device, the first separating unit and/or the second separating unit are configured as one respective wall.

The wall may, in particular, be a wall of a stall. The described holder may be mounted on such a wall so that the livestock cubicle is defined by the wall as a separating unit. With a plurality of livestock cubicles arranged adjacent to one another, the outermost livestock cubicle may be defined by the wall. By means of such an embodiment, the space available may be utilized in the best possible manner. Preferably, either only the first separating unit or only the second separating unit is configured as a wall. However, it is also conceivable that both the first separating unit and the second separating unit are configured as one respective wall. In this case, however, it is preferred if the wall is not an external wall of a stall but, in particular, only a partition of half height.

According to a further preferred embodiment of the separating device, the guide is configured as a slot in the respective holder.

A slot within the meaning used here is an opening with an elongated cross section.

According to a further preferred embodiment of the separating device, the slot is arranged so as to be inclined such that an upper end of the slot is closer to the rear region of the livestock cubicle than a lower end of the slot.

The upper end of the slot is the highest point of the slot with a conventional orientation of the separating device. The lower end of the slot is the lowest point of the slot with a conventional orientation of the separating device. The upper end of the slot acts as an upper stop for the crossmember and the lower end acts as a lower stop.

By the described arrangement of the upper end of the slot in relation to the lower end of the slot, it is achieved that the guide is configured obliquely so that the crossmember may be moved obliquely upwardly such that in this case said crossmember is moved at the same time in the direction of the rear region of the livestock cubicle and/or that the crossmember may be moved obliquely downwardly such that in this case said crossmember is moved at the same time in the direction away from the rear region of the livestock cubicle.

According to a further preferred embodiment of the separating device, at least one of the separating units is configured such that the respective holder is retained at one of a plurality of predetermined heights and/or in one of a plurality of predetermined horizontal positions.

In this embodiment, different predetermined heights and/or predetermined horizontal positions are provided, in each case one thereof being able to be selected. The holder is mounted at this selected height and horizontal position. In conventional operation of the described separating device, the holder remains at this height and horizontal position. By the plurality of predetermined heights and horizontal positions, one and the same separating device may be used, for example, for cows of different sizes.

The horizontal positions are all at the same height. Preferably, the different predetermined horizontal positions are all located on the same line parallel to the respective separating unit. This means that two different horizontal positions are located at different distances from the rear region of the livestock cubicles.

According to a further preferred embodiment of the separating device, the predetermined heights are determined by a plurality of fastening holes on the respective holder and/or on a post of the respective separating unit.

The different heights may be predetermined in each case by a plurality of fastening holes being provided in the holder and/or in the remaining part of the corresponding separating unit, in particular on a post. It is preferred if in each case a plurality of fastening holes is provided both on the respective holder and on the respective post.

As a further feature, an arrangement in particular for a dairy farm is proposed, which comprises:
a plurality of livestock cubicles having one respective head region and one respective rear region, wherein the livestock cubicles are arranged parallel to one another and adjacent to one another with the same orientation,
a plurality of separating units arranged spaced apart from one another, wherein in each case a separating unit is provided between adjacent livestock cubicles and on the lateral edges of the arrangement,
at least one substantially horizontally arranged crossmember,
   wherein at least a portion of the separating units comprises a holder with a guide, the crossmember extending through said guide, wherein the guide is oriented obliquely such that with an upward movement the crossmember is also moved in the direction of the rear region of the livestock cubicle and that the guide and an imaginary horizontal line extending parallel to the respective separating unit encloses a guide angle which is less than 90°.

The particular advantages and design features of the separating device described above are able to be used and transferred to the described arrangement and vice-versa.

It is preferred if each of the separating units has one respective holder. In this case it is particularly preferred if the separating devices are configured as described.

Alternatively, it is preferred if only a portion of the separating units have one respective holder, in particular only every second separating unit. In this case, the particular advantages and design features described above of the separating device may be transferred correspondingly to the arrangement.

In the arrangement, a plurality of livestock cubicles are arranged adjacent to one another. In each case, adjacent livestock cubicles are separated from one another by a separating unit. In this case, a separating unit configured from tubes is preferably provided between adjacent livestock cubicles. In each case, a livestock cubicle which is adjacent on only one side to a further livestock cubicle is arranged on the two lateral edges of the arrangement. On the other sides of these livestock cubicles, which form the lateral edges of the arrangement, however, no further livestock cubicles are provided. Moreover, in each case a separating device is provided on the lateral edges thus formed. This separating device may be formed by tubes. It is, however, also possible in particular that a separating unit configured as a wall is provided at least on one of the two lateral edges.

The number of adjacently arranged livestock cubicles may be selected depending on the space available. Preferably, the arrangement comprises 3 to 30, in particular 20 to 25, livestock cubicles adjacent to one another.

According to a further preferred embodiment of the arrangement, just one crossmember which extends through all of the holders is provided.

In this embodiment, just one crossmember is provided. This means that a plurality of animals are able to ensure a movement of the same crossmember. However, this is not a problem since animals, such as for example cows, stand up so rarely that the probability of adjacent animals injuring one another may be seen to be sufficiently low. The crossmember comprises at least two portions which are connected together by a connecting element. The connecting element may be a flexible connecting element, for example a hose. Alternatively or additionally, the connecting element may be configured in the form of a cable or a chain, i.e. the connecting element has low flexural strength.

In particular if the crossmember is moved by an animal at the edge of the arrangement, the crossmember may be moved obliquely such that the crossmember is no longer oriented parallel to the floor. In particular, at one of the lateral edges of the arrangement the crossmember may be in an upper position in the guide and at the same time at the other lateral edge in a lower position in the guide.

In this embodiment it is preferred if the described arrangement comprises 3 to 6 adjacently arranged livestock cubicles. With such a small number of adjacently arranged livestock cubicles the probability of the animals injuring one another is particularly low.

According to a further preferred embodiment of the arrangement, a plurality of crossmembers is provided, wherein just one of the crossmembers extends through each holder.

In this embodiment, the possibility of the animals in adjacently arranged livestock cubicles becoming injured is further reduced by not just one crossmember being provided but a plurality thereof. Preferably, one respective crossmember is provided in each case for three adjacent livestock cubicles. Particularly preferably, just one respective crossmember is provided for each separating device and thus for each livestock cubicle. In this case, each animal has its own crossmember.

The invention and the technical field are described in more detail hereinafter with reference to the figures. The figures show a particularly preferred exemplary embodiment to which the invention is not limited, however. In particular, it should be mentioned that the figures and, in particular, the size ratios shown are only schematic. In the drawings, schematically:

### BRIEF DESCRIPTION OF THE DRAWINGS

FIG. 1 shows an arrangement, in particular for a dairy farm, with a crossmember in a lower position,

FIG. 2 shows the arrangement of FIG. 1 with the crossmember in an upper position,

FIG. 3 shows a separating unit of the arrangement of FIGS. 1 and 2 with the crossmember in the lower position, and

FIG. 4 shows the separating unit of FIG. 3 with the crossmember in the upper position.

### DETAILED DESCRIPTION OF THE INVENTION

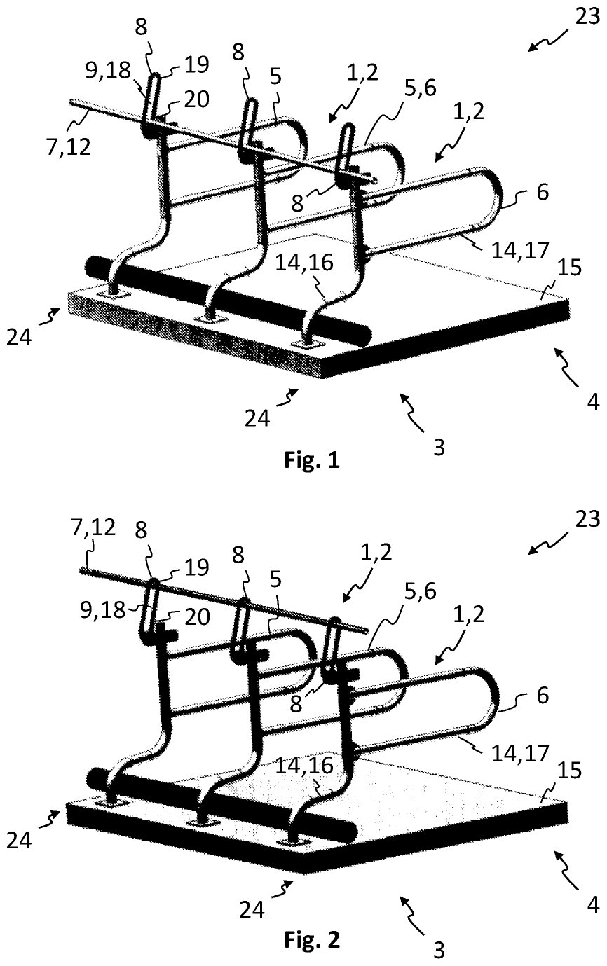

FIGS. 1 and 2 show in each case a perspective view of an arrangement 23, in particular for a dairy farm, which comprises a plurality of, in this case two, livestock cubicles 2 with one respective head region 3 and one respective rear region 4. The livestock cubicles 2 are arranged parallel to one another and with the same orientation adjacent to one another. Moreover, the arrangement 23 comprises a plurality of, in this case three, separating units 5, 6 arranged spaced apart from one another. Each of the two livestock cubicles 2 is respectively defined laterally by a first separating unit 5 and a second separating unit 6. For the left-hand livestock cubicle 2, the separating unit shown to the far left is a first separating unit 5 and the central separating unit is a second separating unit 6. For the right-hand livestock cubicle 2, the central separating unit is a first separating unit 5 and the right-hand separating unit is a second separating unit 6. In this regard, the central separating unit is thus both a first separating unit 5 and a second separating unit 6. In this regard, in each case a separating unit 5, 6 is provided between adjacent livestock cubicles 2 and on lateral edges 24 of the arrangement 23. Moreover, the arrangement 23 comprises a substantially horizontally arranged crossmember 7 which is configured here as a straight bar 12. Each separating unit 5, 6 has a rigidly configured holder 8 with a guide 9, the crossmember 7 extending through said guide. The crossmember 7 is retained loosely in the holders 8. Together with the crossmember 7, the separating units 5, 6 form two separating devices 1—one for each of the livestock cubicles 2.

The first separating unit 5 and the second separating unit 6 in each case are configured from two tubes 14, one thereof forming a post 16 connected to a floor 15 of the livestock cubicles 2 and one forming a loop 17. The holders 8 are retained on the posts 16.

The guide 9 is configured as a slot 18 in the respective holder 8 and is arranged so as to be inclined such that an upper end 19 of the slot 18 is closer to the rear region 4 of the livestock cubicle 2 than a lower end 20 of the slot 18.

FIGS. 1 and 2 show the same exemplary embodiment. In FIG. 1 the crossmember 7 is shown in a lower position at the lower end 20 of the slot 18, whilst the crossmember 7 in FIG. 2 is shown in an upper position, i.e. at the upper end 19 of the slot 18. The crossmember 7 may be moved between the lower position and the upper position.

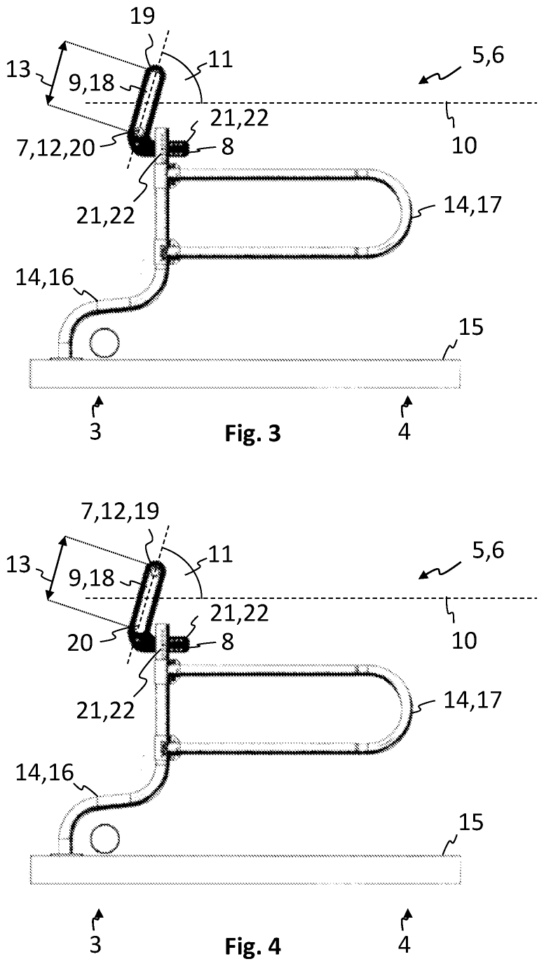

FIGS. 3 and 4 show in each case a side view of the arrangement of FIGS. 1 and 2. In FIG. 3, the crossmember 7 is shown in the lower position, whilst the crossmember 7 in FIG. 4 is shown in the upper position. Thus FIG. 3 corresponds to the situation of FIG. 1 and FIG. 4 corresponds to the situation of FIG. 2.

In FIGS. 3 and 4 it may be identified that the guide 9 is oriented obliquely such that with an upward movement the crossmember 7 is also moved in the direction of the rear region 4 of the livestock cubicle 2, and that the guide 9 and an imaginary horizontal line 10 extending parallel to the respective separating unit 5, 6 enclose a guide angle 11. As may be identified in FIGS. 3 and 4, the guide 9 (for clarification also emphasized here by a dashed line) and the horizontal line 10 as a whole enclose a total of four angles. Of these the guide angle 11 is the angle located top right.

The guide angle 11 is unalterable, less than 90°, greater than 60° and, in particular, is located between 70° and 80°.

Moreover, a guide length 13 which is between 20 and 50 cm, in particular is between 30 and 40 cm, is illustrated.

Moreover, in FIGS. 3 and 4 it may be identified that the holders 8 are retained at one of a plurality of predetermined heights 21 which is made possible by a plurality of fastening holes 22 on the holder 8 and on the post 16. The fastening holes 22 also permit an adjustment of the holder 8 in the horizontal direction parallel to the separating units 5 and 6, i.e. in the left-right direction in FIGS. 3 and 4.

1. A separating device (1) for a livestock cubicle (2) having a head region (3) and a rear region (4), in particular for a livestock cubicle (2) for a dairy farm, comprising
a first vertical separating unit (5),
a second vertical separating unit (6), wherein the first and the second separating unit (5, 6) are arranged spaced apart from one another,
a substantially horizontally arranged crossmember (7), wherein each separating unit (5, 6) comprises a holder (8) with a guide (9), the crossmember (7) extending through said guide, wherein the guide (9) is oriented obliquely such that with an upward movement the crossmember (7) is also moved in the direction of the rear region (4) of the livestock cubicle (2) and that the guide (9) and an imaginary horizontal line (10) extending parallel to the respective separating unit (5, 6) enclose a guide angle (11) which is less than 90°.

2. The separating device (1) of claim 1, wherein the guide angle (11) is greater than 60°.

3. The separating device (1) of claim 1, wherein the guide angle (11) ranges between 70° and 80°.

4. The separating device (1) of claim 1, wherein the holders (8) are configured such that the guide angle (11) is unalterable.

5. The separating device (1) of claim 1, wherein the crossmember (7) is retained loosely in the holders (8).

6. The separating device (1) of claim 1, wherein the holders (8) are of rigid configuration.

7. The separating device (1) of claim 1, wherein the crossmember (7) is configured as a straight bar (12).

8. The separating device (1) of claim 1, wherein the guide (9) has a guide length (13) of at least 20 cm, in particular of at least 30 cm.

9. The separating device (1) of claim 1, wherein the guide (9) has a guide length (13) of a maximum of 50 cm, in particular of a maximum of 40 cm.

10. The separating device (1) of claim 1, wherein the first separating unit (5) and/or the second separating unit (6) are configured from one or more tubes (14).

11. The separating device (1) of claim 1, wherein the first separating unit (5) and/or the second separating unit (6) comprise one respective post (16) connected to a floor (15) of the livestock cubicle (2), and wherein the respective holder (8) is retained on the corresponding post (16).

12. The separating device (1) of claim 1, wherein the first separating unit (5) and/or the second separating unit (6) are configured as one respective wall.

13. The separating device (1) of claim 1, wherein the guide (9) is configured as a slot (18) in the respective holder (8).

14. The separating device (1) of claim 13, wherein the slot (18) is arranged so as to be inclined such that an upper end (19) of the slot (18) is closer to the rear region (4) of the livestock cubicle (2) than a lower end (20) of the slot (18).

15. The separating device (1) of claim 1, wherein at least one of the separating units (5, 6) is configured such that the respective holder (8) is retained at one of a plurality of predetermined heights (21) and/or in one of a plurality of predetermined horizontal positions.

16. The separating device (1) of claim 15, wherein the predetermined heights (21) and/or the predetermined horizontal positions are determined by a plurality of fastening holes (22) on the respective holder (8) and/or on a post (16) of the respective separating unit (5, 6).

17. An arrangement (23), in particular for a dairy farm, which comprises:
a plurality of livestock cubicles (2) having one respective head region (3) and one respective rear region (4), wherein the livestock cubicles (2) are arranged parallel to one another and adjacent to one another with the same orientation,
a plurality of separating units (5, 6) arranged spaced apart from one another, wherein in each case a separating unit (5, 6) is provided between adjacent livestock cubicles (2) and on the lateral edges (24) of the arrangement (23),
at least one substantially horizontally arranged crossmember (7),
wherein at least a portion of the separating units (5, 6) comprises a holder (8) with a guide (9), the crossmember (7) extending through said guide, wherein the guide (9) is oriented obliquely such that with an upward movement the crossmember (7) is also moved in the direction of the rear region (4) of the livestock cubicle (2) and that the guide (9) and an imaginary horizontal line (10) extending parallel to the respective separating unit (5, 6) enclose a guide angle (11) which is less than 90°.

18. The arrangement (23) of claim 17, wherein each of the separating units (5, 6) has one respective holder (8).

19. The arrangement (23) of claim 18, wherein the separating devices (1) are configured as claimed in one of claims 1 to 16.

20. The arrangement (23) of claim 17, wherein just one crossmember (7) which extends through all of the holders (8) is provided.

21. The arrangement (23) of claim 20, wherein the crossmember (7) has at least two portions which are connected together by a connecting element, wherein the connecting element has low flexural strength.

22. The arrangement (23) of claim 17, wherein a plurality of crossmembers (7) is provided, and wherein just one of the crossmembers (7) extends through each holder (8).
